(19) United States
(12) Patent Application Publication
(10) Pub. No.: US 2012/0246390 A1
(43) Pub. Date: Sep. 27, 2012

(54) INFORMATION PROCESSING APPARATUS, PROGRAM PRODUCT, AND DATA WRITING METHOD

(75) Inventors: Tatsunori Kanai, Kanagawa (JP); Tetsuro Kimura, Tokyo (JP); Haruhiko Toyama, Kanagawa (JP); Koichi Fujisaki, Kanagawa (JP); Hiroyoshi Haruki, Kanagawa (JP); Masaya Tarui, Kanagawa (JP); Satohi Shirai, Kanagawa (JP); Akihiro Shibata, Tokyo (JP)

(73) Assignee: KABUSHIKI KAISHA TOSHIBA, Tokyo (JP)

(21) Appl. No.: 13/345,818

(22) Filed: Jan. 9, 2012

(30) Foreign Application Priority Data
Mar. 24, 2011 (JP) 2011-066649

(51) Int. Cl. G06F 12/02

(52) U.S. Cl. 711/103; 711/E12.008

(57) ABSTRACT

According to one embodiment, an information processing apparatus includes an auxiliary storage unit, a non-volatile main storage unit, a secondary cell, a first writing unit, and a second writing unit. The non-volatile main storage unit includes a cache area to temporarily store therein data that is to be stored in the auxiliary storage unit. The first writing unit writes the data into the cache area. The second writing unit writes the data written in the cache area into the auxiliary storage unit when an amount of power in the secondary cell is greater than a predetermined first threshold.

### CROSS-REFERENCE TO RELATED APPLICATION

This application is based upon and claims the benefit of priority from Japanese Patent Application No. 2011-066649, filed on Mar. 24, 2011.

### FIELD

Embodiments described herein relate generally to an information processing apparatus, program product, and data writing method.

### BACKGROUND

Information equipment (information processing apparatus) such as a personal computer (PC), a cellular phone, a tablet-style terminal, and a slate-style terminal stores various kinds of data in a secondary storage (auxiliary storage unit). For the secondary storage, a hard disk drive (HDD), a silicon disk drive (SSD), a memory card (such as an SD card and a compact flash (trademark)) incorporating a flash memory, or the like is adopted. A flash memory chip connected directly to the central processing unit (CPU) may be used as the secondary storage. The data stored in the secondary storage is retained after the power to the information processing apparatus is shut off.

Software installed in such an information processing apparatus includes an operating system that serves as the base program and various application programs that run on this system. The data in the secondary storage is managed in the form of files by the operating system. When the application program makes an access to (reads and writes, for example) the data in the secondary storage, a system call is issued to the operating system to request a file operation (for example, to create, write, read, and delete a file). Part of the operating system, which manages the files, is sometimes referred to as a file system.

In general, the speed of reading data from or writing data into the secondary storage is slower than the speed of reading data from or writing data into the main memory (main storage unit). Thus, the operating system uses a disk cache to efficiently access the data in the slow secondary storage. The operating system temporarily stores data, which is previously read from or written in the secondary storage by the application program, in the disk cache area allocated in the main memory. In response to a request to read data from the application program, the operating system returns the data in the disk cache to the application program, without reading the data from the secondary storage, if the to-be-read data is found in the disk cache. The operation performed by the application program to write the data into the secondary storage is completed when the data is written into the disk cache, and the operating system later writes all the data stored in the disk cache into the secondary storage at a time. As a result, the average time for the application program to perform the operation of reading the data from and writing data into the secondary storage can be reduced, and the frequency of making accesses to the secondary storage can also be reduced. A disk cache is also referred to as a page cache or buffer cache.

In the operating system that incorporates a disk cache, there is a time difference between a point at which the application program writes in the disk cache the data that is to be written into the secondary storage and a point at which this data is actually written into the secondary storage. Because the disk cache area is usually allocated in a volatile main memory, if data that has been written into the disk cache but not yet into the secondary storage is lost due to some failure, the data that is supposed to be written into the secondary storage by the application program is lost. For this reason, in most operating systems, the data that has been written into the disk cache is written from the disk cache into the secondary storage when a certain period of time has passed after the writing or when free space has become small in the disk cache.

### BRIEF DESCRIPTION OF THE DRAWINGS

FIG. 1 is an external view of an information processing apparatus according to an embodiment;

FIG. 2 is a diagram showing the hardware structure of the information processing apparatus according to the embodiment;

FIG. 3 is a block diagram showing an example functional structure of the information processing apparatus according to the embodiment;

FIG. 4 is a diagram explaining the operation of accessing the secondary storage;

FIG. 5 is a flowchart of a flash process; and

FIG. 6 is a flowchart of a flash process according to an embodiment.

### DETAILED DESCRIPTION

In general, according to one embodiment, an information processing apparatus includes an auxiliary storage unit, a non-volatile main storage unit, a secondary cell, a first writing unit, and a second writing unit. The non-volatile main storage unit includes a cache area to temporarily store therein data that is to be stored in the auxiliary storage unit. The first writing unit writes the data into the cache area. The second writing unit writes the data written in the cache area into the auxiliary storage unit when an amount of power in the secondary cell is greater than a predetermined first threshold.

Exemplary embodiments of the information processing apparatus are explained in detail below with reference to the attached drawings.

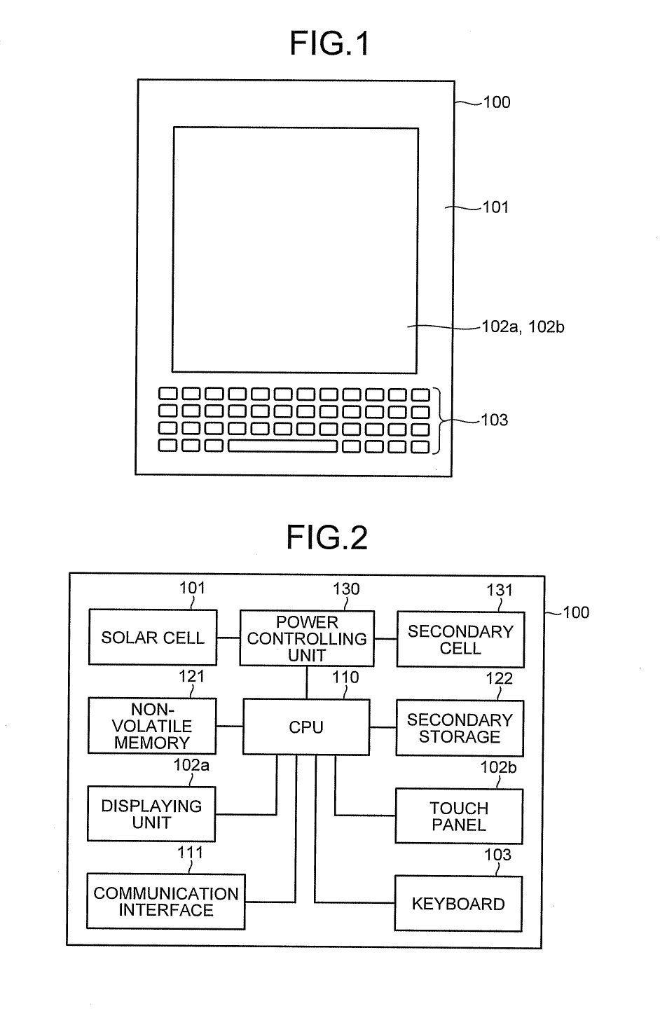

FIG. 1 is an external view of an information processing apparatus 100 according to an embodiment. In FIG. 1, a tablet-style information processing apparatus 100 is presented. The information processing apparatus 100 is equipped with a displaying unit 102a, such as a reflective liquid crystal display, which is a low power consumption display, or an electronic paper, on the surface of the terminal. The information processing apparatus 100 also includes a solar cell 101 in an area of the surface of the terminal other than that of the displaying unit 102a. The information processing apparatus 100 includes a touch panel 102b on the surface of the displaying unit 102a to serve as a pointing device. The information processing apparatus 100 further includes a keyboard 103 in an area of the surface of the terminal that does not overlap the displaying unit 102a. Alternatively, the keyboard 103 may be formed by overlaying a transparent touch panel 102b onto the surface of the solar cell 101. Furthermore, the keyboard 193 may be formed as a mechanical keyboard by using a transparent material or a material with a small light blocking portion.

FIG. 2 is a block diagram showing an example hardware structure of the information processing apparatus 100 according to the present embodiment. As the main components of the hardware structure, the information processing apparatus 100 includes the solar cell 101, the displaying unit 102a, the touch panel 102b, the keyboard 103, a CPU 110, a communication interface 111, a non-volatile memory 121, a secondary storage 122, a power controlling unit 130, and a secondary cell 131.

The information processing apparatus 100 operates by power generated by the solar cell 101. However, the power generated by the solar cell 101 cannot cover all the power consumed in the information processing apparatus 100 at the peak time during the operation (during some processing is being executed). For this reason, surplus power that is generated by the solar cell 101 at the time of idling (when the information processing apparatus 100 is waiting for a response from the user or when it is not in use) is charged into the secondary cell 131. During the operation, the power controlling unit 130 performs control so that the power stored in the secondary cell 131 is supplied to the units of the information processing apparatus 100. Such power control is sometimes called peak shift. The solar cell 101 serves as a supplying unit that supplies power to each unit of the information processing apparatus 100 including the secondary cell 131.

The secondary cell 131 may be formed with a single battery such as a lithium ion battery or an electric double-layer capacitor. Alternatively, the secondary cell 131 may be formed with a combination of them. For example, a combination may be adopted in such a manner that the power generated by the solar cell 101 is first stored in the electric double-layer capacitor, and then the stored power is charged into the lithium ion battery.

The CPU 110 executes an application program and the operating system to control the entire apparatus.

The non-volatile memory 121 is used as a main memory and is a storage unit (main storage unit) of a non-volatile memory element. For example, the non-volatile memory 121 may be formed with a magnetic random access memory (MRAM) that can read and write at high speed. Alternatively, a phase change memory (PCM, sometimes also referred to as a PRAM or a PCRAM) or a resistance random access memory (ReRAM) may be adopted as the non-volatile memory 121.

The secondary storage 122 is a storage unit (auxiliary storage unit) that stores therein data and programs required by the information processing apparatus 100. For example, the secondary storage 122 may be formed with a storage unit in which a flash memory chip is incorporated. An SD card or SSD may also be adopted for the secondary storage 122.

If the secondary storage 122 is not provided and only the non-volatile memory 121 of a capacity large enough to store all the data and programs that would otherwise be stored in the secondary storage 122 is provided, a problem of increase in cost or the like arises. For this reason, the structure according to the present embodiment is configured to have a main storage unit (non-volatile memory 121) and an auxiliary storage unit (secondary storage 122), and a disk cache is provided in the main storage unit to cache the data in the auxiliary storage unit.

In the present embodiment, a non-volatile memory element is used as the main storage unit instead of a volatile memory element such as a dynamic random access memory (DRAM). Thus, even when there is some trouble, data that is to be written into the secondary storage 122 would not be lost. However, because a disk cache is provided in the main storage unit as described above, a process of writing the data written in the disk cache into the secondary storage 122 (flash process) is required.

The information processing apparatus 100 includes, as an input/output device, the displaying unit 102a such as electronic paper or a low-power-consumption liquid crystal display, the transparent touch panel 102b overlaid on the surface of the displaying unit 102a, the keyboard 103, and the communication interface 111. The apparatus may be designed in such a manner that, without providing a keyboard 103, a virtual keyboard is displayed on the displaying unit 102a and covered with the touch panel 102b. Any input/output interface other than the touch panel 102b and the keyboard 103 may also be incorporated or may be connected to the apparatus.

The communication interface 111 is an interface that is incorporated to perform communications through, for example, a wireless local area network (LAN). The communication protocol is not limited to the wireless LAN, but any protocol such as wired LAN, Bluetooth, ZigBee, infrared communication, visible light communication, optical network, telephone network, and the Internet can be adopted.

The power controlling unit 130 has a function of controlling the amount of power stored in the secondary cell 131 and causing the external components such as the CPU 110 to detect the amount of power stored in the secondary cell 131. The function of causing the CPU 110 to detect the amount of power stored in the secondary cell 131 may be realized by, for example, the power controlling unit 130 interrupting the CPU 110 to notify it of the amount of power when the amount stored in the secondary cell 131 becomes smaller than, or greater than, a predetermined amount. As another method, the structure may be configured in such a manner that, when a command is received from the CPU 110, the power controlling unit 130 sends the current amount of power back to the CPU 110.

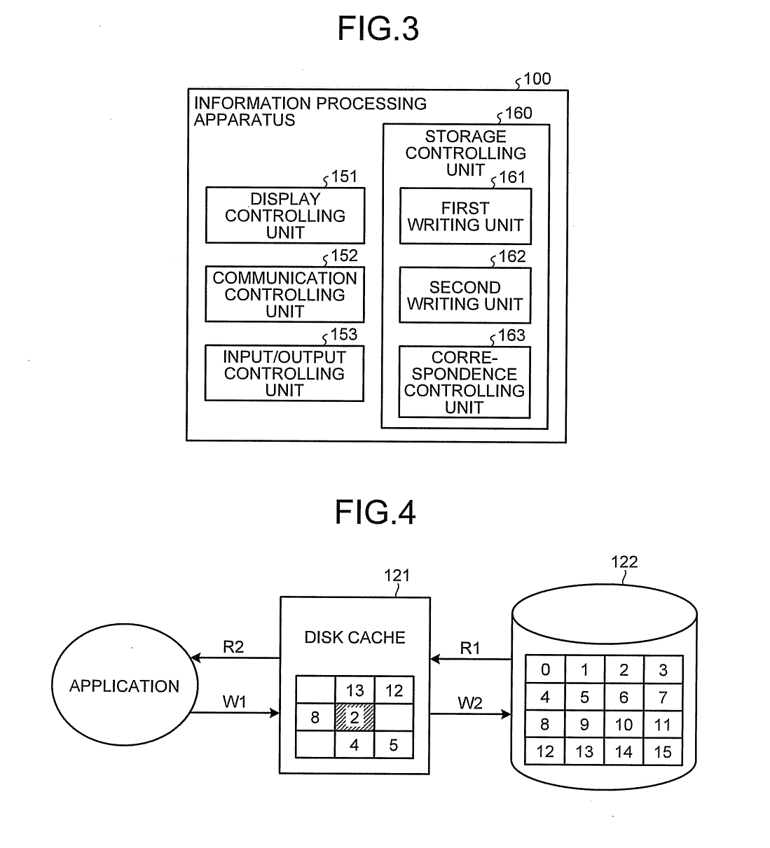

FIG. 3 is a block diagram showing an example functional structure of the information processing apparatus 100 according to the present embodiment. In FIG. 3, the hardware structure indicated in FIG. 2 is omitted. The information processing apparatus 100 includes a display controlling unit 151, a communication controlling unit 152, an input/output controlling unit 153, and a storage controlling unit 160.

The functions of these units (the display controlling unit 151, the communication controlling unit 152, the input/output controlling unit 153, and the storage controlling unit 160) may be realized as the functions of the operating system. At least one of the units may be implemented as a hardware circuit.

The display controlling unit 151 controls the process of displaying information on the displaying unit 102a. The communication controlling unit 152 controls the process of communicating with an external device (not shown) by way of the communication interface 111. The input/output controlling unit 153 controls the process of inputting and outputting data by use of the touch panel 102b and the keyboard 103.

The storage controlling unit 160 controls accesses to data in the non-volatile memory 121 and the secondary storage 122. For example, the storage controlling unit 160 allocates a cache area (hereinafter, “disk cache”) for disk caching in the non-volatile memory 121, and temporarily stores in the disk cache the data that is read from or written into the secondary storage 122. Then, when a certain condition is satisfied, the storage controlling unit 160 writes the data temporarily stored in the disk cache back into the secondary storage 122. The storage controlling unit 160 includes a first writing unit 161, a second writing unit 162, and a correspondence controlling unit 163.

The first writing unit 161 writes the data of the secondary storage 122 for which an access request is issued from the application program or the like, into the disk cache. The second writing unit 162 writes the data into the secondary storage 122 when a certain condition that is specified to write the data of the disk cache into the secondary storage 122 is satisfied. For example, the second writing unit 162 writes the data written in the disk cache into the secondary storage 122 upon receipt of a write request from the application program, when the amount of power in the secondary cell 131 is greater than a predetermined threshold (first threshold).

The correspondence controlling unit 163 controls the correspondence between the disk cache and the storage area of the secondary storage 122. For example, the correspondence controlling unit 163 can be realized by a software module called a file system that is incorporated in a regular operating system.

In general, the operating system divides the secondary storage 122 into blocks of a certain size to control. The typical size of one block is 4 kilobytes. Similarly, the correspondence controlling unit 163 separates the entire storage area of the secondary storage 122 into 4-kilobyte blocks, and sequentially assigns numbers (block numbers) to the blocks. Then, the correspondence controlling unit 163 handles the block numbers as the addresses of the blocks.

The correspondence controlling unit 163 controls the correspondence between a file name that designates the data and the block number (or block numbers) of the secondary storage 122 in which the data is actually stored under this file name. More specifically, in a file system widely used on the Linux (trademark) and Unix (trademark), a data structure called i-node is employed to control such correspondence. Furthermore, in the file system widely used on Windows (trademark), a data structure called FAT is incorporated to control this correspondence. The file system also checks the state of each block in the secondary storage 122, whether it is in use or not.

As described above, an operating system such as Linux (trademark) is installed in the information processing apparatus 100 according to the present embodiment. The operating system uses a disk cache to control the data stored in the secondary storage 122.

Next, the operation performed by the operating system (the units of FIG. 3) when the application program makes an access to the secondary storage 122 is explained with reference to FIG. 4. FIG. 4 is a diagram explaining the operation performed when making an access to the secondary storage 122. Each of the rectangles in the secondary storage 122 indicated in FIG. 4 corresponds to one block, and the number assigned to each block corresponds to the address of the block.

In the information processing apparatus 100, the storage controlling unit 160 determines the area of the disk cache on the non-volatile memory 121. The storage controlling unit 160 also divides the disk cache into blocks of the same size as the unit size for managing the secondary storage 122. The correspondence controlling unit 163 checks the state of each block of the disk cache if it is in use or not in use, and if it is in use, the correspondence controlling unit 163 checks which block of the secondary storage 122 the stored data corresponds to and checks whether the block in use is dirty. A block that is in use and dirty means that the data written into the block of the disk cache is not yet written into the corresponding block of the secondary storage 122. Each of the rectangles in the disk cache illustrated in FIG. 4 indicates one block. The blocks with numbers assigned are in use, and each number indicates the address of the corresponding block of the secondary storage 122. The shaded block indicates a block that is in use and dirty. The blocks without any number indicate blocks that are not in use.

The procedure of the process ((1) to (4) shown below) performed by the application program to read data stored in the secondary storage 122 is explained with reference to FIG. 4.

(1) The application program issues an open system call to the storage controlling unit 160 to designate the name of the file in which the data to be read is stored.

(2) The storage controlling unit 160 obtains the address of a block (or addresses of blocks) of the secondary storage 122 in which the data is stored, from the designated file name.

(3) The application program issues a read system call to the storage controlling unit 160 to read data.

(4) The storage controlling unit 160 checks to see whether the data in the block of the secondary storage 122 in which the data to be read is stored is stored in the disk cache. If the data is in the disk cache, the storage controlling unit 160 returns this data to the application program (R2 in FIG. 4). If the data is not in the disk cache, the storage controlling unit 160 (the first writing unit 161) reads the data from the secondary storage 122 and writes it into an unused block of the disk cache (R1 in FIG. 4), and returns this data to the application program (R2 in FIG. 4).

Next, the procedure of the process ((1) to (5) shown below) performed by the application program to write data into the secondary storage 122 is explained with reference to FIG. 4.

(1) The application program issues an open system call to the storage controlling unit 160 to designate the name of the file into which the data is to be written.

(2) The application program issues a write system call to notify the storage controlling unit 160 of data that is to be written.

(3) The write process is performed as shown in (4), if the data is to be written into a new file. If the data is to be written over an existing file, the write process is performed as shown in (5). When the data is to be written over an existing file but the file is to be expanded beyond the range that is currently assigned in the secondary storage 122, the procedure (4) of the write process should be followed for new blocks.

(4) When writing into a new file, the first writing unit 161 acquires any necessary number of unused blocks in the disk cache and writes the data provided from the application program therein (W1 in FIG. 4). The correspondence controlling unit 163 changes the state of the blocks into which the data has been written to an in-use state. Furthermore, the correspondence controlling unit 163 acquires a certain number of unused blocks in the secondary storage 122 that is necessary to write the data, and brings them into correspondence with the blocks of the disk cache.

(5) When writing the data over an existing file, the correspondence controlling unit 163 obtains from the designated file name the address of a block (or addresses of blocks) of the secondary storage 122 in which the data is stored. If the block of the disk cache that corresponds to the block of the secondary storage 122 is already in use, the first writing unit 161 writes the data over this block (W1 in FIG. 4). In addition, the correspondence controlling unit 163 changes the state of the block to a dirty state. If there is no block in the disk cache that corresponds to the block of the secondary storage 122, the correspondence controlling unit 163 assigns an unused block in the disk cache. Then, the first writing unit 161 writes the data into the assigned block (W1 in FIG. 4). Furthermore, the correspondence controlling unit 163 changes the state of the block in which the data is written to a dirty state, and also brings it into correspondence with the block of the secondary storage 122.

For any dirty block that is in use in the disk cache, or in other words, for any block the data of which has been written by the application program but is not yet written in the corresponding block of the secondary storage 122, the second writing unit 162 writes this data into the secondary storage 122 at a predetermined timing (W2 in FIG. 4). This is referred to as a flash process. For example, on Linux (trademark), the flash process is executed by a daemon program called pdflush. On most conventional operating systems such as Linux (trademark), the data is written from the disk cache into the secondary storage 122 by the flash process, mainly in the following two situations:

(1) When there is any dirty block that is in use in the disk cache that stores therein the data written by the application program, but the data has not been written into the secondary storage 122 for a long time after the data is written in: The second writing unit 162 writes the data of this block into the corresponding block of the secondary storage 122. Then, the correspondence controlling unit 163 changes the state of the block to an in-use and not-dirty state. The block that is in use and dirty in the disk cache should be changed, not to an unused state, but to an in-use and not-dirty state so that the data in the disk cache becomes readable when the application program later wishes to read this data. An in-use and not-dirty block in the disk cache can be handled as an unused block if needed.

(2) When there are too many blocks that are in use and dirty in the disk cache and there are only few blocks that are unused and blocks that are in use but not dirty: The second writing unit 162 writes the data of the in-use and dirty block into the corresponding block of the secondary storage 122. Then, the correspondence controlling unit 163 changes this block to an in-use and not-dirty state or an unused state.

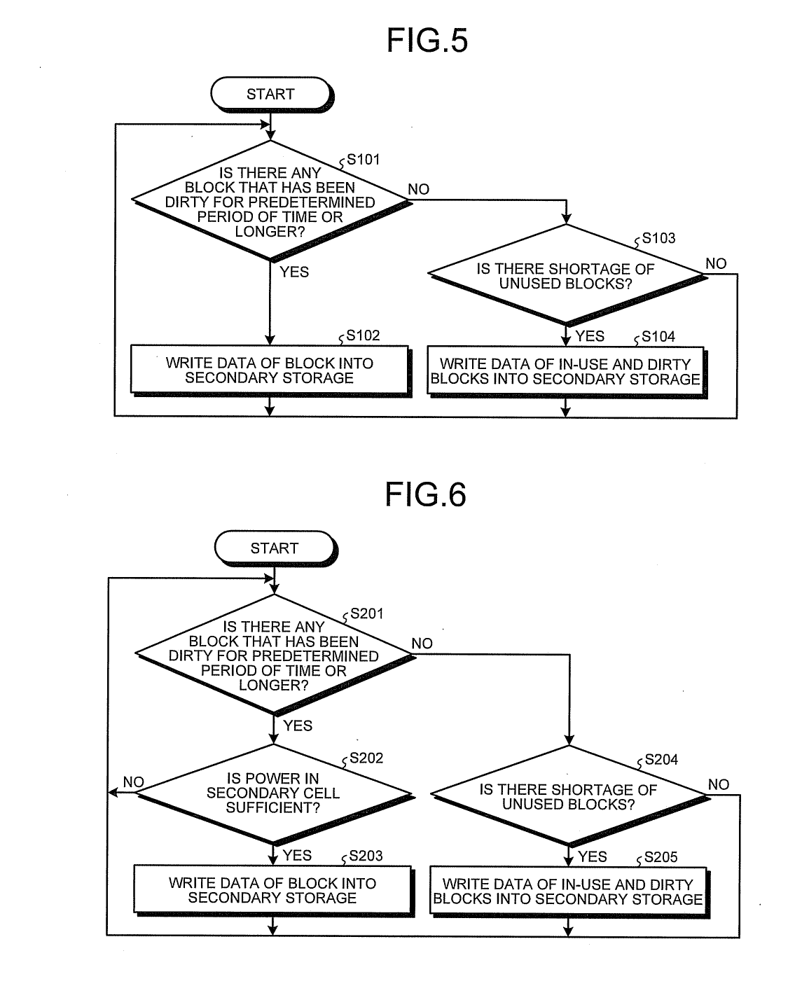

This flash process is executed by following the procedure as indicated in FIG. 5. FIG. 5 is a flowchart of an example of the flash process.

First, the storage controlling unit 160 determines whether there is any block in the disk cache that has been in an in-use and dirty state for a predetermined period of time (e.g., several tens of seconds) or longer (step S101). If there is any (yes at step S101), the second writing unit 162 writes the data into the corresponding block of the secondary storage 122 (step S102). The correspondence controlling unit 163 changes this block to an in-use and not-dirty state.

If there is no block that has been in such a state for the predetermined period of time (no at step S101), the storage controlling unit 160 further determines whether there is shortage of unused blocks in the disk cache (step S103). For example, the storage controlling unit 160 determines whether the number of unused blocks in the disk cache is greater than or equal to a predetermined threshold (second threshold), and judges that there is shortage when the number is smaller than the threshold.

If there is no shortage (no at step S103), the system returns to step S101, and the process is repeated. If there is shortage (yes at step S103), the second writing unit 162 selects a block that is in use and dirty in the disk cache, and writes the data of the selected block into the corresponding block of the secondary storage 122 (step S104). The correspondence controlling unit 163 changes the block whose data has been written to an in-use and not-dirty state. In determining whether there is shortage of unused blocks, a block that is in use but not dirty can be counted as an unused block because it can be turned into an unused block any time.

The information processing apparatus 100 according to the present embodiment switches between executing and not-executing of the flash process in accordance with the amount of power in the secondary cell 131, as indicated in FIG. 6. FIG. 6 is a flowchart of the entire flash process according to the present embodiment. The flash process of FIG. 6 is different from FIG. 5 in that the operation of step S202 in which the amount of power in the secondary cell 131 is taken into consideration is added. The operations of steps S201 and S203 through S205 are the same as those of steps S101 and S102 through S104 in FIG. 5, and thus detailed explanation thereof is omitted here.

First, it is determined whether there is any block in the disk cache that has been in an in-use and dirty state for a predetermined period of time (e.g., several tens of seconds) or longer (step S201). If there is any such block (yes at step S201), the storage controlling unit 160 determines whether the amount of power in the secondary cell 131 is sufficient (step S202). As described above, the storage controlling unit 160 can obtain the current amount of power in the secondary cell 131, for example, by an interrupt from the power controlling unit 130 or in response to a command of requesting the current amount of power. Then, the storage controlling unit 160 determines that the amount of power is sufficient (yes at step S202), for example, when the amount of power in the secondary cell 131 is greater than the predetermined threshold (first threshold). If this is the case, the second writing unit 162 writes the data into the corresponding block of the secondary storage 122 (step S203). Furthermore, the correspondence controlling unit 163 changes the in-use and dirty block in the disk cache to an in-use and not-dirty state.

When the amount of power is insufficient (no at step S202), the system returns to step S101, without executing writing to the secondary storage 122, and repeats the process. Therefore, power consumption can be reduced.

The operation of judging the amount of power in the secondary cell 131 (step S202) does not always have to be executed at the timing as shown in FIG. 6. For example, the order of steps S201 and S202 in FIG. 6 may be reversed. In addition, when the judgment at step S204 is “yes”, the process of further judging the amount of power in the secondary cell 131 may be conducted in the same manner as step S202 so that the operation of step S205 can be performed only when there is a sufficient amount of power.

Because the information processing apparatus 100 allocates the disk cache area in the non-volatile memory 121, the data in the in-use and dirty blocks in the disk cache would not be erased in the event of a failure. Thus, it is determined during the boot-up of the operating system whether the system is normally shut down in the previous session or the power is shut off due to some failure. If the power is shut off due to some failure, any block that is in use and dirty in the disk cache (i.e., a block the data of which has been written into the disk cache by the application program but not in the corresponding block of the secondary storage 122) is detected, and the data of this block should be written into the secondary storage 122.

This function can be realized, for example, by following the procedure shown below. First, an area for determining whether the system is normally shut down is provided, for example, on the non-volatile memory 121. During boot-up, a first value (e.g., 0) is written into this area. A second value (e.g., 1) is written if the system is normally shut down. The storage controlling unit 160 reads the value written in this area before writing the first value (0) at boot-up. If the value is not the second value (1), the storage controlling unit 160 determines that the system has not been shut down normally.

The present embodiment can be applied not only to data management on the file system or the like of the above operating system, but also to the management of the database stored in the secondary storage 122 and the database cache in the main memory in a database management system. Furthermore, the present embodiment can be applied to the management of the secondary storage 122 for the swap to realize a virtual memory and a page cache allocated in the main memory. Especially on recent operating systems such as Linux (trademark) and Unix (trademark), the disk cache is often combined with a page cache for virtual memory. When the present embodiment is applied to such a combined cache, the effects of the embodiment can be achieved for the disk cache and also for the swap.

In the above embodiment, the solar cell 101 is used as a supplying unit, but the supplying unit is not limited to the solar cell 101. Alternatively, a method of externally supplying power by use of wireless transmission and a method of obtaining power from vibration or heat may be adopted. The present embodiment is effective especially when power generation or power supply is not stable.

According to the present embodiment, the frequency of writing data into the secondary storage 122 can be reduced, and thus the power consumed during the operation of writing to the secondary storage 122 can also be reduced. Furthermore, when the power stored in the secondary cell 131 is insufficient, the power consumption during the flash process can be reduced. Thus, the reduced amount of power can be used for operations of higher priorities such as dialog processing with the user.

The program executed by the information processing apparatus according to the present embodiment is recorded in a file of an installable or executable format in a computer readable recording medium such as a compact disk read only memory (CD-ROM), a flexible disk (FD), a compact disk recordable (CD-R), of a digital versatile disk (DVD), and offered as a computer program product.

Furthermore, the program executed by the information processing apparatus according to the present embodiment may be stored on a computer that is connected to a network such as the Internet and downloaded by way of the network. In addition, the program executed by the information processing apparatus according to the present embodiment may be provided by way of the network such as the Internet and distributed.

The program according to the present embodiment may be incorporated, and offered in a ROM or the like.

The program executed by the information processing apparatus according to the present embodiment has a module structure including the above units (the display controlling unit 151, the communication controlling unit 152, the input/output controlling unit 153, and the storage controlling unit 160). The above units are loaded on the main storage unit (non-volatile memory 121) when the CPU 110 reads and executes the program from the recording medium such as the secondary storage 122, and the above units are generated on the main storage unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an auxiliary storage unit;
a non-volatile main storage unit that includes a cache area to temporarily store therein data that is to be stored in the auxiliary storage unit;
a secondary cell;
a first writing unit that writes the data into the cache area; and
a second writing unit that writes the data written in the cache area into the auxiliary storage unit when an amount of power in the secondary cell is greater than a predetermined first threshold.

2. The apparatus according to claim 1, wherein the second writing unit writes the data into the auxiliary storage unit when the amount of power is greater than the first threshold and the data has been written into the cache area for a predetermined period of time.

3. The apparatus according to claim 1, wherein the first writing unit writes the data into the cache area in units of blocks, each block being a storage area of a predetermined size, and
the second writing unit writes the data written in the cache area into the auxiliary storage unit when the number of blocks in the cache area in which no data is written is smaller than a predetermined second threshold.

4. The apparatus according to claim 1, further comprising a supplying unit that supplies power to the secondary cell.

5. A program product having a computer readable medium including programmed instructions, wherein the instructions, when executed by a computer comprising an auxiliary storage unit, a non-volatile main storage unit that includes a cache area to temporarily store therein data that is to be stored in the auxiliary storage unit, and a secondary cell, causes the computer to perform:
writing the data into the cache area; and
writing the data written in the cache area into the auxiliary storage unit when an amount of power in the secondary cell is greater than a predetermined first threshold.

6. The program product according to claim 5, wherein
upon writing the data into the auxiliary storage unit, writing the data written in the cache area into the auxiliary storage unit when the amount of power is greater than the first threshold and the data has been written into the cache area for a predetermined period of time.

7. The program product according to claim 5, wherein
upon writing the data into the cache area, writing the data into the cache area in units of blocks, each block being a storage area of a predetermined size, and
upon writing the data into the auxiliary storage unit, writing the data written in the cache area into the auxiliary storage unit when the number of blocks in the cache area in which no data is written is smaller than a predetermined second threshold.

8. A data writing method implemented in an information processing apparatus, wherein
the information processing apparatus includes: an auxiliary storage unit; a non-volatile main storage unit that includes a cache area to temporarily store therein data that is to be stored in the auxiliary storage unit; a secondary cell, the method comprising:
writing the data into the cache area; and
writing the data written in the cache area into the auxiliary storage unit when an amount of power in the secondary cell is greater than a predetermined first threshold.
